(19) United States
(12) Patent Application Publication
(10) Pub. No.: US 2016/0338172 A1
(43) Pub. Date: Nov. 17, 2016

(54) Signaling System

(71) Applicants: Michelle Fern, Minneapolis, MN (US); John Jancsek, Minneapolis, MN (US)

(72) Inventors: Michelle Fern, Minneapolis, MN (US); John Jancsek, Minneapolis, MN (US)

(21) Appl. No.: 14/709,810

(22) Filed: May 12, 2015

(51) Int. Cl. H05B 37/02; F21V 33/00; H05B 33/08

(52) U.S. Cl. CPC H05B 37/0227; H05B 33/0842; H05B 37/0272; F21V 33/0076; F21W 2111/10

(57) ABSTRACT

The signaling system includes; a microprocessor, a light array in communication with the microprocessor, and a motion sensor in communication with the microprocessor. The microprocessor includes software which causes the light array to display light patterns in response to signals from the motion sensor, the signals indicating changes in the position of said motion sensor.

### CROSS REFERENCE TO RELATED APPLICATIONS

There are no applications related to this application.

### STATEMENT REGARDING FEDERALLY SPONSORED RESEARCH OR DEVELOPMENT

No invention claimed in this application was made under Federally sponsored research or development.

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

1. Field of the Invention

The signaling system relates to the field of interpreting operator gestures into electronic and light signals.

2. Description of Related Art

The production of displays which indicate the intentions of a user as indicated by the user's actions is an old art relating to such diverse means a smoke signals, telephone, telegraph, and television. Solutions to this problem relating to the signaling of intentions by a user of a vehicle or in the communication with a user of a vehicle are manifold. One class of inventions uses operator selected displays to accomplish the communication of operator intentions. U.S. Pat. No. 4,760,372, to Watson, and U.S. Pat. No. 5,617,303 to Izzo, are typical of this class of solutions to the instant communications problem.

Another class of solutions focuses on changes in operating conditions of the user's vehicle. U.S. Pat. No. 4,843,368, to Paulos, and U.S. Pat. No. 6,690,266, to Jack et al, are typical of this class of solutions.

In yet another class of solutions the position of the user's hands, or other body parts, is used to produce the desired indication. U.S. Pat. No. 8,144,030, to Lipke is typical of this class of solutions.

### BRIEF SUMMARY OF THE INVENTION

The signaling system includes; a microprocessor, a light array in communication with the microprocessor, and a motion sensor in communication with the microprocessor. The microprocessor includes software which causes the light array to display light patterns in response to signals from the motion sensor, said signals indicating changes in the position of said motion sensor. The purpose of the signaling system is to detect movements of the wearer 6 of the motion sensor and display light patterns on the light array which indicate the wearers intended actions. This function is of particular interest to cyclists, policemen, Highway Flagmen, Aircraft Directors, and other individuals who must communicate their intentions to others at distances and under conditions which render the user's manual gesticulations useless or ambiguous to a viewer.

### BRIEF DESCRIPTION OF THE SEVERAL VIEWS OF THE DRAWING

FIG. 1 is an illustration of the glove embodiment of the Signaling system

FIG. 2 is an illustration a second embodiment of the glove signaling system.

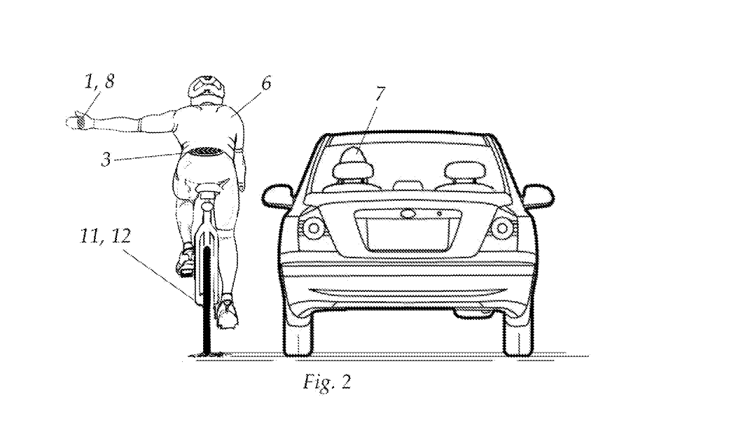

FIG. 3 is an illustration of a second embodiment of the glove signaling system with the user and automobile exchanged positions.

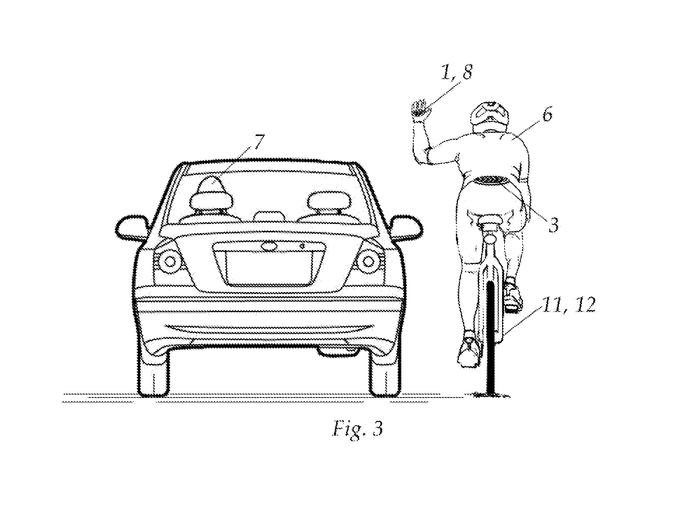

FIG. 4 is a block diagram of the signaling system.

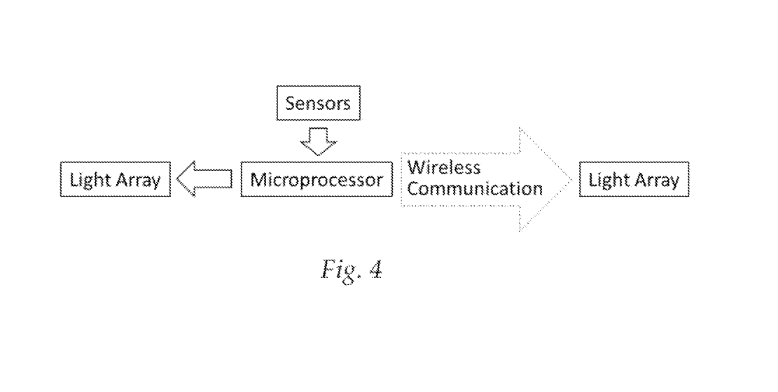

FIG. 5 is an illustration of a wrist worn embodiment of the signaling system.

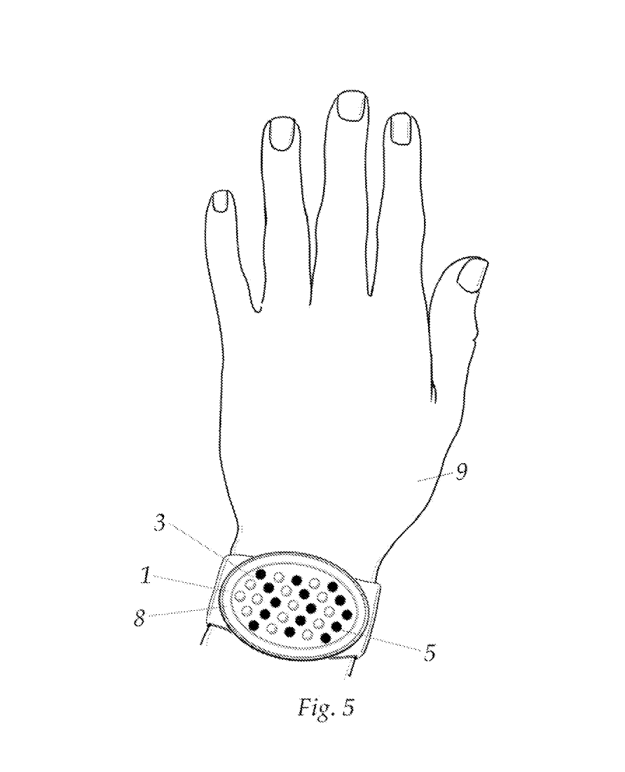

FIG. 6 is an illustration of a glove embodiment of the signaling system.

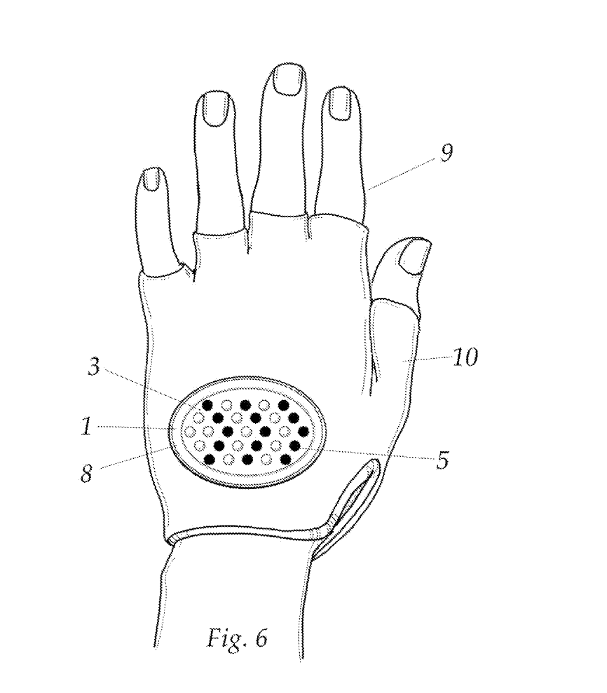

FIG. 7 is an illustration of a band mounted embodiment of the signaling system.

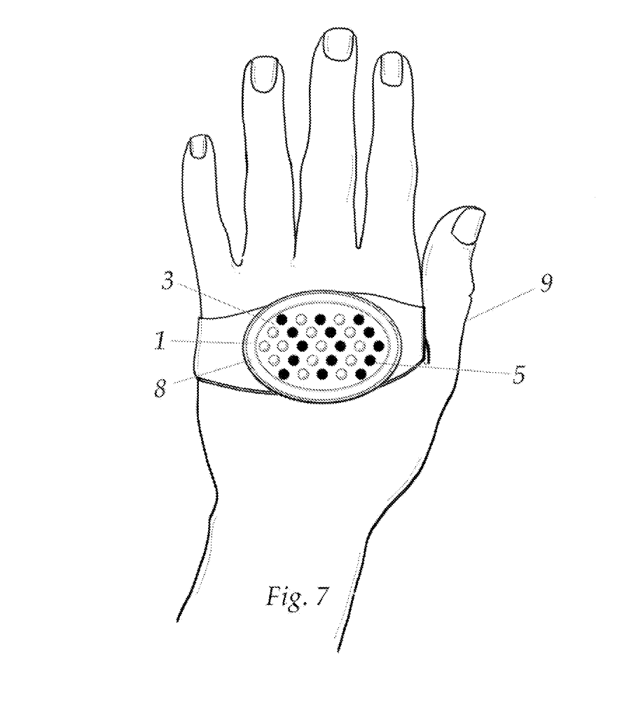

FIG. 8 is an illustration of a second wrist mounted embodiment of the signaling system.

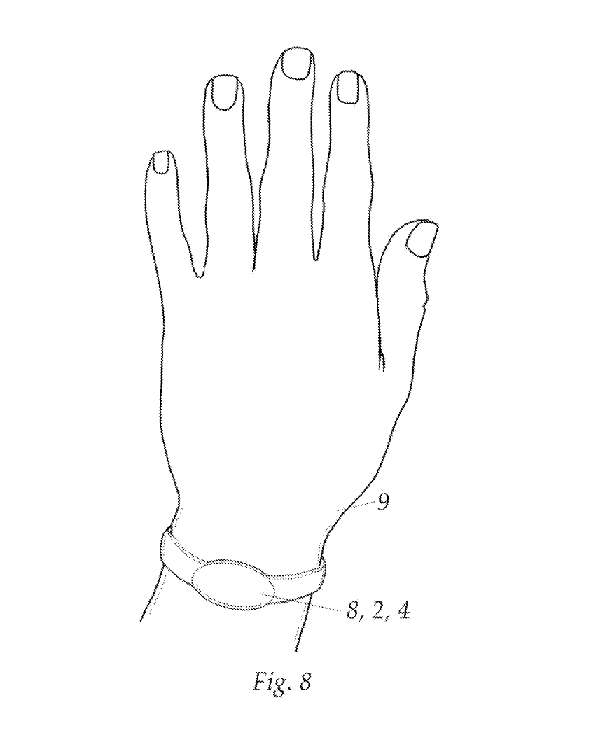

FIG. 9 is an illustration of a flight direction embodiment of the signaling system.

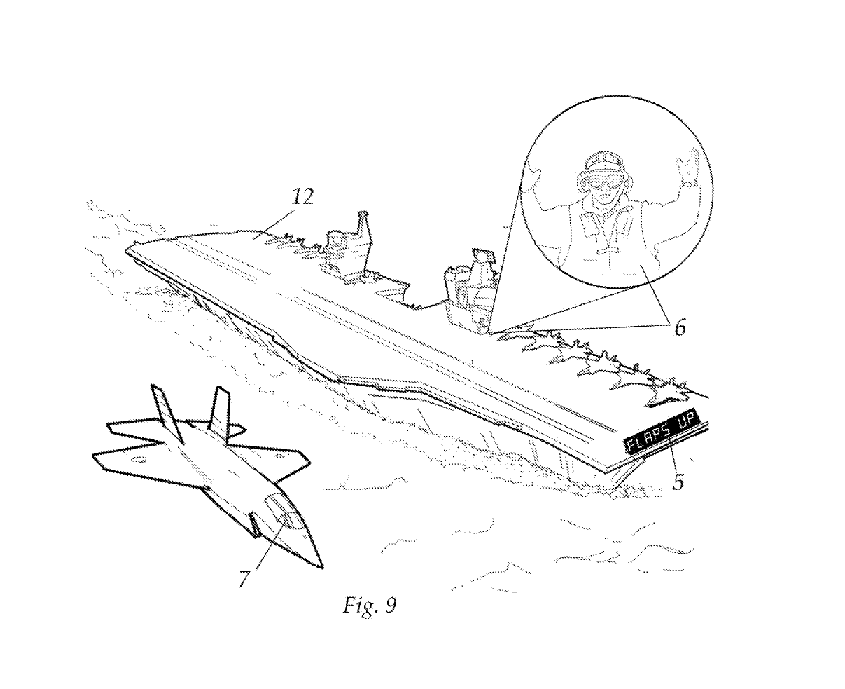

### DETAILED DESCRIPTION OF THE INVENTION

The signaling system 1 includes; a microprocessor 2, a light array 3 in communication with the microprocessor 2, and a motion sensor 4 in communication with the microprocessor 2. The microprocessor 2 includes software which causes the light array 3 to display light patterns 5 in response to signals from the motion sensor 4, said signals indicating changes in the position of said motion sensor 4. The purpose of the signaling system 1 is to detect movements of the wearer 6 of the motion sensor 4 and display light patterns 5 on the light array 3 which indicate the wearers 6 intended actions. This function is of particular interest to cyclists, policemen, Highway Flagmen, Aircraft Directors, and other individuals who must communicate their intentions to others at distances and under conditions which render the user's manual gesticulations useless or ambiguous to a viewer 7.

The microprocessor 2 may be any modern computer on a chip capable of storing instructions, receiving signals from a motion sensor 4, and controlling a light array 3. The Intel Pentium family of microprocessors, Microchip, Atmel, NXP and ST Micro embedded processors are exemplary. The software present in the microprocessor 2 interprets the signals received by the microprocessor 2 from the motion sensor 4 and determines if the wearer's hand has changed position. When a change is detected the microprocessor's 2 software determines if the motion has achieved a new position and if so, commands the light array 3 to display a new light pattern 5.

Communications among the motion sensor 4, microprocessor 2, and light array 3 may be accomplished by a hardwired connection or other wireless device such as a low energy Blue Tooth Chip.

The pad 8 may be in any form suitable for a wearer 6 to attach to himself. By way of example this could be a glove 10 worn by the wearer 6, or as a pad 8 with a strap for attachment to the wearer's hand 9. This pad 8 includes one or more motion sensors 4 which communicate positional or accelerometer data to the microprocessor 2. This communications may take place via hardwire or wireless means. The pad 8 may be further equipped with a strap.

It will be recognized that the motion sensor 4 and pad 8 combination should be worn by the wearer 6 on the body part which the wearer 6 employs to generate the desired indications. The device can be worn on one or both hands, arms or other body appendage that can allow the wearer to communicate through gestures

The Microprocessor 2 and light array 3 may be configured as a part of or attached to the pad 8, but may also be located elsewhere, such as the wearers 6 back or even at a remote location from the wearer 6. Similarly the microprocessor 2 may be located with the light array 3 or at a third location such as the wearer's 6 bicycle 11, anywhere on the wearer 6, or the wearer's vehicle 12, or at a location remote from both the pad 8, and light array 3.

The light array 3 may be constructed of any devices which emit light, Light emitting diodes are preferred because of their relative brightness and low power consumption. However, any device which is capable of emitting light in response to commands from a microprocessor 2 will be suitable.

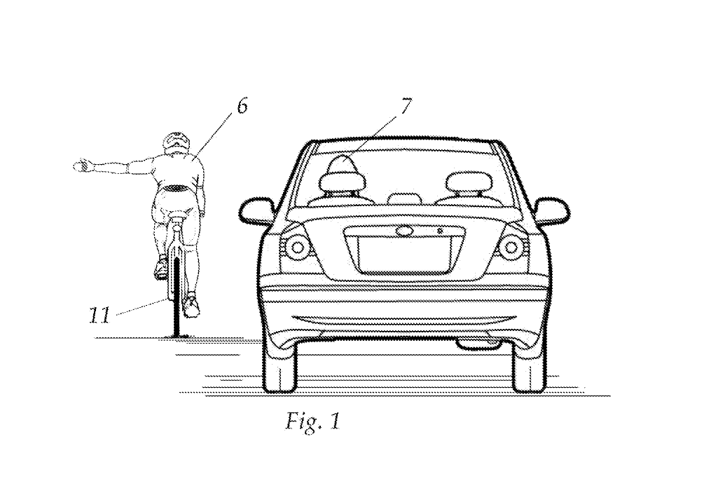

FIG. 1 shows a flow chart for the software which could be used in one embodiment of the invention. This software implements the following three exemplary sets steps:

### Set 1:

1) Rider moves left hand to a palm up position.
2) The signaling system 1 detects that the wearer 6 has moved the pad 8 to the palm up position and is activated waiting for next position change.
3) Rider moves left hand from palm up to a position extending left hand from left shoulder straight out to the left side of the body with left arm horizontal and left thumb pointed up.
4) The device detects the change of position
5) The microprocessor 2 controls the Light array 3 in a pattern indicating a left turn.
6) Rider moves left hand to a palm up position
7) The Microprocessor 2 turns off the light array 3

### Set 2:

1) Rider moves left hand to a palm up position
2) The signaling system 1 detects that the wearer 6 has moved the pad 8 to the palm up position and is activated waiting for next position change.
3) Rider moves left hand from palm up to a position extending left hand from left shoulder with elbow bent at 90 degrees, left hand directly above the left elbow and back of the left hand facing behind.
4) The device detects the change of position
5) The microprocessor 2 controls the Light array 3 in a pattern indicating a right turn.
6) Rider moves left hand to a palm up position
7) The Microprocessor 2 turns off the light array 3

### Set 3:

1) Rider moves left hand to a palm up position
2) The Signaling system 1 detects that the wearer 6 has moved the pad 8 to the palm up position and is activated waiting for next position change.
3) Rider moves left hand from palm up to a position extending left hand straight down from left shoulder with the back of the left hand facing forward
4) The device detects the change of position
5) The microprocessor 2 controls the Light array 3 in a pattern indicating a stop.
6) Rider moves left hand to a palm up position
7) The Microprocessor 2 turns off the light array 3

I claim:

1) A signaling system comprising:
a) a microprocessor;
b) a light array in communication with said microprocessor;
c) a motion sensor in communication with said microprocessor, said microprocessor including software which causes the light array to display light patterns in response to signals from said motion sensor, said signals indicating changes in position of said motion sensor, and
d) a pad configured for attachment to a user.

2) The signaling system of claim 1 further comprising a strap for attaching said pad to a hand of said for attaching to a hand of said user, or other part of the body.

3) The Signaling system of claim 1 wherein said pad is configured as a glove.

4) The signaling system of claim 1 wherein said motion sensor is attached to said pad.

5) The signaling system of claim 1 wherein said microprocessor, said light array, and said motion sensor are attached to said pad.

6) The signaling system of claim 1 wherein said pad and said motion sensor are affixed to different users.

7) A signaling system comprising:
a) a first microprocessor;
b) a motion sensor in communication with said first microprocessor, said first microprocessor including software which creates signals related to changes in position of said motion sensor, and
c) a light array with a second microprocessor including software that controls electronic components in response to signals received and said second microprocessor located separate from said first microprocessor and in communication with said first microprocessor; the second microprocessor receives signals from the first microprocessor.

8) The signaling system of claim 7 wherein multiple devices worn by a user have individual signals sent to said first microprocessor.
